(19) United States
(12) Patent Application Publication
(10) Pub. No.: US 2014/0038539 A1
(43) Pub. Date: Feb. 6, 2014

(54) IMBALANCE CORRECTION IN A DEMODULATOR WITH FULL BAND SAMPLING

(71) Applicant: STMICROELECTRONICS (GRENOBLE 2) SAS, Grenoble (FR)

(72) Inventor: Jacques MEYER, Saint-Martin-Le-Vinoux (FR)

(73) Assignee: STMICROELECTRONICS (GRENOBLE 2) SAS, Grenoble (FR)

(21) Appl. No.: 13/950,640

(22) Filed: Jul. 25, 2013

(30) Foreign Application Priority Data
Aug. 3, 2012 (FR) 1257579

(51) Int. Cl. H04B 1/16

(52) U.S. Cl. CPC H04B 1/16
USPC 455/205

(57) ABSTRACT

A method for demodulating phase quadrature modulated signals in a band of channels includes transposing the band around zero, and selecting a channel in the transposed band. A first pair of phase quadrature signals forming a first complex signal is extracted from the selected channel. A second pair of phase quadrature signals forming a second complex signal is extracted from a symmetrical channel of the selected channel. The method further includes establishing a correlation product based on the first and second complex signals, and correcting the two complex signals to make the correlation product tend towards zero.

### FIELD OF THE INVENTION

The invention relates to the demodulation of data transmitted in a channel selectable among several channels of a useful band.

### BACKGROUND OF THE INVENTION

FIG. 1 shows an example of a useful frequency band with several channels to be demodulated, which is in the context of current satellite transmission standards. The useful bandwidth, centered on F_{b}=1650 MHz, is between 950 and 2150 MHz, and includes several adjacent channels having a maximum data rate of 40 Mbps. This is based on quadrature phase-shift keying (QPSK) modulation.

FIG. 2 schematically shows a conventional direct conversion demodulator to extract data from a selected channel in the band of FIG. 1. The selected channel (FIG. 1) is centered on a frequency F_{c}. The received RF signal is supplied to a pair of mixers 10 which multiply the signal by two sinusoids of frequency F_{c} and a phase offset of 90° to produce two phase quadrature signals I and Q. It follows from this structure that the channel is transposed around zero frequency, as shown by the dotted lines in FIG. 1. Each of the quadrature signals is filtered in a filter 12 to keep only the signals representative of the selected channel, which are then converted to digital signals in an analog-to-digital converter 14.

The frequency used for the mixers 10 is approximate, so the signals T and Q are produced with a frequency error. It follows that the vector formed of the samples of signals I and Q rotates at the error frequency Fₑ. A reverse rotation circuit 16 is provided for rotating the vector in the reverse direction at frequency Fₑ. The frequency Fₑ is determined by a regulation loop based on the output values of the reverse rotation circuit 16.

In addition, various errors are introduced by the analog components of the demodulator in FIG. 2. The mixer 10, in particular, introduces a phase and amplitude imbalance in the I and Q channels. U.S. Pat. No. 7,109,787 discloses an approach to correct this imbalance.

Receivers should be capable of simulcasting the contents of multiple channels, such as, for example, to multiple TVs. For this purpose, several demodulation chains of the type of FIG. 2 are provided in a single receiver, with each chain being independently adjustable on a different channel. However, a demodulation system is a relatively expensive element in a receiver, especially because of its analog components.

### SUMMARY OF THE INVENTION

In view of the foregoing background, there is a need for a demodulator structure that can be produced at low cost for receiving several channels simultaneously.

This need is addressed by a method for demodulating phase quadrature modulated signals in a useful band comprising a plurality of channels. The method may comprise transposing the useful band around zero, selecting a channel in the transposed band, extracting from the selected channel a first pair of phase quadrature signals forming a first complex signal, extracting from a symmetrical channel of the selected channel a second pair of phase quadrature signals forming a second complex signal, and establishing a correlation product based on the first and second complex signals. The two complex signals may then be corrected to make the correlation product tend towards zero.

The correlation product may be carried out between the error of the first complex signal relative to its estimated value and the second complex signal.

The correction may be carried out with a matrix whose coefficients are determined from a complex value obtained by dividing the correlation product by the power of the received signal corresponding to the second complex signal.

The correlation product and the correction may be carried out during reception of a header including known symbols, wherein the estimated value assumes the known values of the symbols.

A demodulator may extract data from a channel pertaining to a useful band comprising a plurality of channels. The demodulator may comprise a demodulation stage configured to extract a first pair of phase quadrature signals at the center frequency of the useful band, a main path configured to extract from the first pair of signals a second pair of phase quadrature signals at the frequency of a selected channel in the useful band, and an auxiliary path configured to extract from the first pair of signals a third pair of phase quadrature signals at the frequency opposite to that of the selected channel. A matrix may be configured to provide amplitude and angular correction of the vectors formed by the components of the first pair of signals. A circuit may be configured to establish the coefficients of the matrix from a correlation product based on the complex values formed by the second and third pairs of signals.

More particularly, the demodulator may comprise a plurality of main paths configured to extract from the first pair of signals a plurality of pairs of phase quadrature signals at the frequencies of respective channels selected in the useful band, and a correction matrix respectively placed in each of the main paths. A control circuit may be configured to operate the auxiliary path successively at the opposite frequencies of the selected channels to establish the coefficients of the corresponding matrices.

### BRIEF DESCRIPTION OF THE DRAWINGS

Other advantages and features will become more clearly apparent from the following description of particular embodiments of the invention provided for exemplary purposes only and represented in the appended drawings, in which:

FIG. 1 is a plot showing an exemplary useful band with several channels to be demodulated in accordance with the prior art.

FIG. 2 schematically shows a conventional direct conversion receiver for phase quadrature modulated signals in accordance with the prior art.

FIG. 3 schematically shows an embodiment of a full band demodulator for demodulating multiple channels simultaneously, sharing the same analog components, in accordance with the present invention.

FIG. 4 is a plot showing a useful band transposed by a demodulator of the type shown in FIG. 3.

FIG. 5 schematically shows a demodulator of the type shown in FIG. 3 with an imbalance correction circuit.

### DETAILED DESCRIPTION OF THE PREFERRED EMBODIMENTS

FIG. 3 schematically shows an embodiment of a demodulator for demodulating multiple channels simultaneously using a single set of mixers 10′, filters 12′, and analog-to-digital converters 14′, which are considered to be the most expensive components in a demodulation system. These analog components are designed to operate on the full useful band transposed around frequency zero. Thus, the mixers 10′ operate at the central frequency F_{b} of the band (e.g., 1650 MHz) instead of operating at the frequency of the selected channel. The filters 12′ are designed to cut off at the boundaries of the transposed band (e.g., ±600 MHz) instead of cutting off at the boundaries of a channel. The converters 14′ operate at least at twice the cutoff frequency of the transposed band (e.g., 1.6 GHz) to sample all signals in the useful band. Current technologies allow the design of analog-to-digital converters operating at several GHz.

For each channel to demodulate in the useful band, a reverse rotation circuit 16′ is provided after the analog-to-digital converters 14′. Instead of operating at an error frequency Fₑ, the reverse rotation circuit 16′ operates at the transposed frequency of the channel: F′_{c}=F_{c}−F_{b}. This reference frequency applied to the reverse rotation circuit 16′ is adjusted in a conventional manner by a servo-controlled correction term. This is done to reflect the difference between the set frequency and the actual transposed channel frequency. Each rotation circuit 16′ is followed by a filter 18 which cuts off at the boundaries of the selected channel, and outputs the desired pair of baseband signals Z′.

FIG. 4 illustrates the useful band of FIG. 1 as transposed about zero by the demodulator of FIG. 3. A selected channel has a transposed frequency F′_{c} and its symmetrical channel has a transposed frequency ˜F′_{c}. Because the demodulator is designed to operate with quadrature signals or complex signals, a given channel and its symmetric channel may be treated independently to convey distinct information.

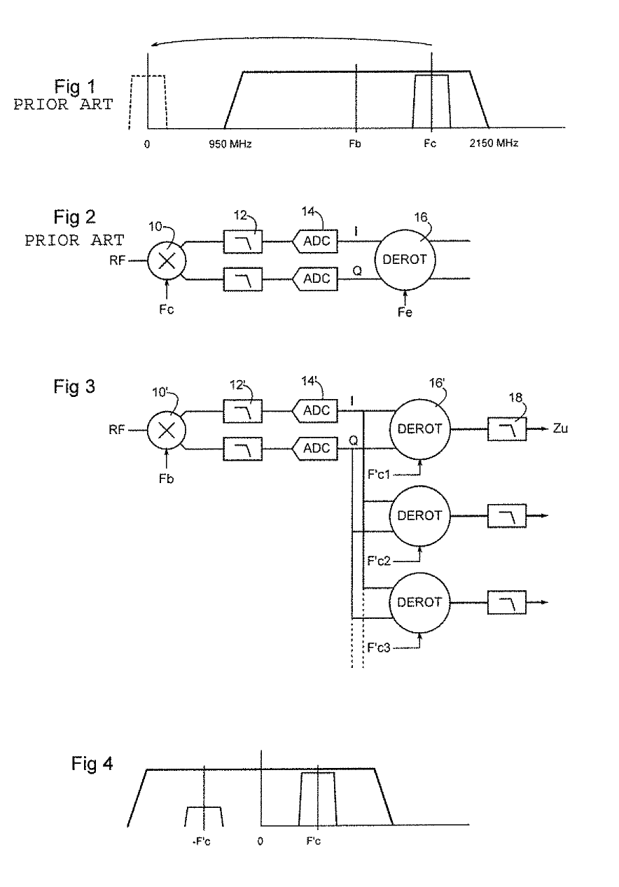

In the demodulators of FIGS. 2 and 3, a mismatch between the mixers causes an amplitude and phase imbalance in the I and Q channels. This imbalance has a disruptive effect that differs in the demodulators of FIGS. 2 and 3, as shown below.

It is assumed that ω_{b}=2πF_{b} is the central angular frequency of the useful band, and ω=2π(F_{c}−F_{b})=2πF′_{c} is the angular frequency of the selected channel in the transposed band (FIG. 4).

A first pair of quadrature modulated signals x and y is transmitted in the channel of carrier frequency F_{c}. This pair is represented by the complex number Z=x+jy. The radio frequency modulated signal is expressed by:

$$\begin{matrix}RF = Re ( Z {e}^{j ( {ω}_{b} + ω ) t} ) \\ = 1 \text{/} 2 ( Z {e}^{j ( {ω}_{b} + ω ) t} + Z * {e}^{- j ( {ω}_{b} + ω ) t} ) \\ = x cos ( {ω}_{b} + ω ) t - y sin ( {ω}_{b} + ω ) t\end{matrix}$$

where Re( ) denotes the real part, and Z*=x−jy is the conjugate complex of Z.

The full band demodulator, of the type of FIG. 3, receives the RF signal and demodulates it (10′) by quadrature carriers having an angular frequency −ω_{b}. The demodulator further introduces an imbalance, expressed by an amplitude error 2α and a phase error 2θ, so that the resulting quadrature signals I and Q are expressed by:

I=(1+α)RF cos(−ω_{b}t+θ),

Q=(1−α)RF sin(−ω_{b}t−θ)

Or, using the exponential notation:

I=(1+α)(Ze^{i(ω}^{_{b}}^{+ω)t}+Z*e^{-j(ω}^{_{b}}^{t+θ)t}(e^{j(-ω}^{_{b}}^{t+θ)}+e^{j(ω}^{_{b}}^{t-θ)})/4,

Q=(1−α)(Ze^{i(ω}^{_{b}}^{+ω)t}+Z*e^{-j(ω}^{_{b}}^{t+θ)t}(e^{-j(ω}^{_{b}}^{t+θ)}−e^{j(ω}^{_{b}}^{t+θ)})/4j

Filtering-out the terms having angular frequency 2ω_{b} (12′) yields:

I=(1+α)(Ze^{j(ωt+θ)}+Z*e^{-j(ωt+θ)})/4,

Q=−j(1−α)(Ze^{j(ωt-θ)}−Z*e^{j(-ωt+θ)})/4

Z′=I +jQ denotes the raw complex signal as produced by the filters 12′. Replacing I and Q by their expressions and developing the calculations yields:

$${Z}^{′} = 1 / 2 Z ( cos θ + j α sin θ ) {e}^{j ω t} + 1 / 2 Z * ( - j sin θ + α cos θ ) {e}^{- j ω t}$$

Thus, for small values of α and θ, and removing the ½ factor:

Z′=Ze^{jωt}+Z*e^{-ωt}B_{Z}

B_{Z}=α−jθ is a complex factor characterizing the imbalance in the channel of angular frequency ω.

The desired signal Z is recovered at angular frequency ω. Also, an image of Z* is recovered at angular frequency −ω. Conversely, a signal S transmitted in the channel of angular frequency −ω creates an image proportional to S* at angular frequency ω:

S′=Se^{-jωt}+S*e^{jωt}B_{S}

B_{S} is the factor of imbalance in the channel of angular frequency −ω.

The signals at the output of the converters 14′ convey the sum of the signals Z′ and S′. After extraction of the desired channel, by a rotation at angular frequency −ω (16′) and low-pass filtering (18), the terms e^{-jωt} are canceled. The useful baseband signal is then expressed, within a gain factor, by: Zᵤ=Z+B_{S}S*.

Thus, the signal is disturbed by the contents of the symmetrical channel by a complex factor B_{S} that increases with the imbalance.

The above calculations are applicable to a direct conversion receiver of the type of FIG. 2, which corresponds to the particular case where ω is zero, ω_{b} is the angular frequency of the selected channel, and Z=S, as the selected channel and its symmetrical are then merged. In this case Zᵤ=Z+BZ*. Since the values Z and Z* are deductible from each other, it is relatively straightforward to estimate B and determine the correction to apply to the signals I and Q to compensate for the imbalance. This is disclosed in U.S. Pat. No. 7,109,787. However, this technique does not apply when the disturbing term B_{S}S* is based on a variable S that is completely independent of Z, as in the full band demodulator of FIG. 3.

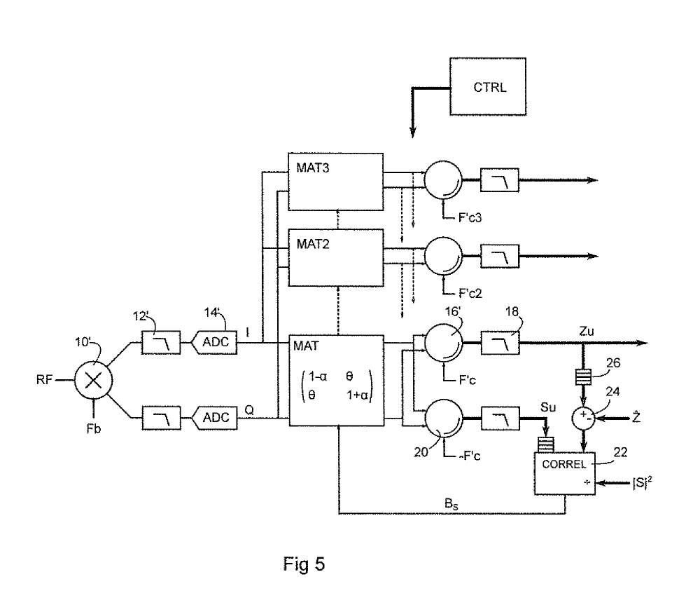

FIG. 5 schematically shows an embodiment of a full band demodulator capable of correcting the imbalance. The signals I and Q produced by the converters 14′ go through a correction matrix MAT before they are supplied to the reverse rotation circuit 16′, as also disclosed in U.S. Pat. No. 7,109,787. This correction matrix can be expressed by:
1−α θ
θ 1+α

A matrix involving less computation may be preferred, derived from the first by applying a gain 1+α and a rotation θ:
1 0
2θ 1+2α

In general, one can use any matrix derived from the first by applying any gain or rotation, since these parameters are compensated for automatically by an automatic gain control and the control loop of the reverse rotation circuit.

These matrix coefficients are approximate, assuming that the values α and θ are small. They remain to be determined.

Compared to the demodulator of FIG. 3, the demodulator of FIG. 5 has an auxiliary route to extract the data S from the symmetry of the selected channel. For this purpose, the output of the matrix MAT is also supplied to a reverse rotation circuit 20 controlled at frequency b−F′_{c}.

Like signal Z, the signal S undergoes an imbalance characterized by a factor B_{Z}, whereby the useful signal Sᵤ is extracted as: Sᵤ=S+B_{Z}Z*. A circuit 22 establishes the product of signals Zᵤ and Sᵤ:

C=ZᵤSᵤ=ZS+B_{Z}B_{S}Z*S*+B_{Z}|Z|²+B_{S}|S|².

It is assumed that the baseband signals have a zero mean value. For example, in QPSK modulation, each of the signals x and y, components of the complex number Z, carries a series of binary values. A pair of binary values conveyed by the signals x and y is called a symbol. The binary values 0 and 1 are represented by opposite analog values, normalized to −1 and +1. In addition, the modulation systems are designed to implement a data transformation which rapidly makes the sliding average of the signals tend to zero.

Thus, by calculating a sliding average <C> of product C, a correlation product is operated that cancels every term with uncorrelated factors that have a zero mean value: the mean value of each of terms ZS, B_{Z}B_{S} and Z* S* is zero. Remains: <C>=B_{Z}|Z|²+B_{S}|S|².

Factors B_{Z} and B_{S} depend on the frequency of the channels. According to a first approximation, it can be assumed that they depend mainly on the absolute value of the frequency. It is permissible to consider them equal in the case of two symmetrical channels. Then: <C>=B_{S}(|Z|²+|S|²).

Values |Z|² and |S|² are the powers of the received signals. They are constant and are usually determined for other purposes in a demodulator. Factor B_{S} is a complex value and is derived by dividing the sliding average <C>, also a complex value, by the sum of the powers of the signals Z and S. Factor B_{S} is thus determined, and the parameters α and θ used in the correction matrix MAT may also be determined.

Due to delays in the distribution of the clock signal, it is likely that the converters 14′ sample the signals with a substantially constant offset in time. This causes a phase shift (translated by the angular error θ) that increases in absolute value with the frequency and retains the same slope over the entire band. In other words, the phase shift influences the selected channel and is symmetrical in opposite directions so that the respective angular errors θ of the two channels diverge when the frequency increases. In such a situation, especially in the higher frequencies of the band, factors B_{S} and B_{Z} can no longer be considered equal, thus making it difficult to determine factor B_{S} by a correlation product as described above.

This difficulty disappears if the receiver is equipped with a system for compensating offsets due to delays in the clock distribution. It is also possible by design, to ensure that the clock paths leading to the two converters 14′ have the same impedance at the point where they separate from a common clock line. The two converters may be matched.

To relax design constraints, a correlation product is carried out between the error of signal Zᵤ and the signal S. The error of signal Zᵤ, established by a subtractor 24, is expressed by Zᵤ−Ẑ, where Ẑ denotes the estimated value of Zᵤ, which may ideally be equal to the original symbol Z. This estimated value is often determined for other needs in a demodulator. It generally corresponds to the theoretical value closest to the raw demodulated value Zᵤ. For example, in a QPSK modulation, the estimated value Ẑ takes one of four normalized complex values 1+j, 1−j, −1+j, −1−j, according to the quadrant in which the value Zᵤ falls.

For the production of the estimated value Ẑ for a current value Zᵤ that are not immediate, buffers 26 are provided at the input of the subtractor 24, and in the path of signal Sᵤ before the correlator 22. This enables providing the correlator with values having a same timestamp for signals Sᵤ, Zᵤ and Ẑ.

The product is then expressed by:

$$\begin{matrix}{C}^{′} = ( {Z}_{u} - {Z}^{\hat{}} ) {S}_{u} \\ = ( Z - {Z}^{\hat{}} + {B}_{s} {S}^{*} ) ( S + {B}_{z} {Z}^{*} ) \\ = ( Z - {Z}^{\hat{}} ) S + ( Z - {Z}^{\hat{}} ) {B}_{z} {Z}^{*} + {B}_{s} {\vert S \vert}^{2} + {B}_{z} {B}_{s} {Z}^{*} {S}^{*}\end{matrix}$$

The factor (Z−Ẑ) is the difference between the original symbol as received by the demodulator in the RF signal and its ideal estimated value. This difference is theoretically zero since the original symbol is considered ideal. The signal Z as received is subject to noise in the transmission. Thus, the difference (Z−Ẑ) produced in the demodulator corresponds to the noise, which is correlated with no other variable in the expression of the product. In addition, the variables Z* and S* are not correlated. Thus, the sliding average <C′> may be expressed by:

<C′>=B_{S}|S|²

With this correlation product, the terms involving the unbalance factor B_{Z} can thus be removed from the desired channel. It is sufficient to divide the complex correlation product by the power of signal S to produce factor B_{S}, thereby the parameters α and θ used in the correction matrix MAT. As mentioned above, the signal power is normally available in any demodulator for other needs. Often, the average amplitude is kept constant by an automatic gain control loop. The power is then the square of the set value of the control loop.

The correlation product is performed on a statistically sufficient number of symbols, for example, one thousand, and in particular, for smoothing the transient errors on the estimated value Ẑ. If the symbols are known values, for example, reference symbols included in headers, it may be sufficient to calculate the correlation only over the length of the header. If the received symbols are known, the estimated values will be accurate and known in advance. The average of the uncorrelated components of the product tends rapidly to zero, after receiving a few headers.

The coefficients of the matrix, with α and θ initially zero, may be adjusted by using iterations of a loop that makes the correlation product tend to zero, or they may be adjusted in a single iteration. The former alternative is used rather when the received symbols are unknown and the correlation product is achieved over a large number of symbols. This avoids instability problems. The latter alternative is used rather when the headers include known reference symbols. In this case, the estimated value Ẑ takes the known values of the symbols.

An advantage of a demodulator of the type of FIG. 5 is that the analog elements 10′, 12′, 14′ may be shared between several channels to be demodulated in parallel. For each additional channel to demodulate in parallel, a path is provided that includes a correction matrix (MAT2, MAT3 . . . ) receiving the output of the converter 14′, a reverse rotation circuit 16′ controlled at the transposed frequency of the channel (F′c2, F′c3 . . . ), and a filter 18.

As mentioned above, the coefficients of the matrix depend on the frequency of the channel. This is why one matrix may be provided for each channel to demodulate in parallel. However, the matrix coefficients vary little over time, wherein the auxiliary channel 20 and the correlation calculation circuits 22, 24, 26 may be shared to adjust the coefficients of each matrix. A control circuit CTRL is then provided to operate the auxiliary path successively at the opposite frequencies of the channels to be demodulated, to connect the shared circuits in the different paths, and to establish the coefficients of the corresponding matrices.

The auxiliary path may serve only to adjust the coefficients of the matrix during a relatively short phase, and does not need to operate in real time like the path for demodulating the selected channel. Its functionality may be realized in software, based on a set of values collected at startup and stored in memory. These values may, in particular, correspond to a known sequence.

Although the above description is based on an example of a QPSK modulation, the disclosed method for determining correction matrix coefficients may be used in any demodulation using quadrature signals, such as multiple PSK (MPSK) or QAM.

1-7. (canceled)

8. A method for demodulating phase quadrature modulated signals in a band having a plurality of channels, the method comprising:
transposing the band around zero;
selecting a channel in the transposed band;
extracting from the selected channel a first pair of phase quadrature signals forming a first complex signal;
extracting from a symmetrical channel of the selected channel a second pair of phase quadrature signals forming a second complex signal;
establishing a correlation product between an error of the first complex signal relative to its estimated value and the second complex signal; and
correcting the first and second complex signals to make the correlation product tend towards zero.

9. The method of claim 8, wherein the correction is carried out with a matrix having coefficients determined from a complex value obtained by dividing the correlation product by a power of a received signal corresponding to the second complex signal.

10. The method of claim 9, wherein the complex value resulting from the division is expressed approximately by:
B_{S}=α−jθ,
and the matrix is approximated by:
$$\vert \begin{matrix}1 - α & θ \\ θ & 1 + α\end{matrix} \vert$$
where B_{S} is a factor of imbalance in a channel, α is an amplitude error imbalance and θ is a phase error imbalance.

11. The method of claim 8, wherein the correlation product and the correction are carried out during reception of a header including known symbols, with the estimated value assuming the known values of the symbols.

12. A method for demodulating signals comprising:
transposing a frequency band around a selected frequency, with the frequency band having a plurality of channels therein;
selecting a channel in the transposed frequency band;
extracting from the selected channel a first pair of phase quadrature signals forming a first complex signal;
extracting from a symmetrical channel of the selected channel a second pair of phase quadrature signals forming a second complex signal;
establishing a correlation product between an error of the first complex signal relative to its estimated value and the second complex signal; and
correcting the first and second complex signals to make the correlation product tend towards a correction value.

13. The method of claim 12, wherein the signals being demodulated comprise phase quadrature modulated signals.

14. The method of claim 12, wherein the selected frequency is zero, and wherein the correction value is zero.

15. The method of claim 12, wherein the correction is carried out with a matrix having coefficients determined from a complex value obtained by dividing the correlation product by a power of a received signal corresponding to the second complex signal.

16. The method of claim 15, wherein the complex value resulting from the division is expressed approximately by:
B_{S}=α−jθ,
and the matrix is approximated by
$$\vert \begin{matrix}1 - α & θ \\ θ & 1 + α\end{matrix} \vert$$
where B_{S} is a factor of imbalance in a channel, α is an amplitude error imbalance and θ is a phase error imbalance.

17. The method of claim 12, wherein the correlation product and the correction are carried out during reception of a header including known symbols, with the estimated value assuming the known values of the symbols.

18. A method for extracting data from a plurality of channels within a band, the method comprising:
extracting a first pair of phase quadrature signals at a center frequency of the band;
operating a plurality of main paths to extract from the first pair of signals a plurality of second pairs of phase quadrature signals at the frequencies of respective channels selected in the band;
operating an auxiliary path for each main path to extract from the first pair of signals a third pair of phase quadrature signals at a frequency opposite the frequency of the selected channel of the main path;
using a matrix for each main path to perform an amplitude and angular correction of vectors formed by components of the first pair of signals; and
providing coefficients for the matrix from a correlation product based on complex values formed by the respective second pair of signals and the third pair of signals.

19. The method of claim 18, further comprising:
operating a correction matrix in each of the main paths; and
operating the auxiliary path successively at the opposite frequencies of the selected channels, and to generate the coefficients of the corresponding matrices.

20. The method of claim 18, wherein the correlation product is carried out between an error of the complex value formed by the respective second pair of signals relative to its estimated value, and the complex value formed by the third pair of signals.

21. A demodulator to extract data from a channel within a band having a plurality of channels, the demodulator comprising:
a demodulation stage configured to extract a first pair of phase quadrature signals at a center frequency of the band;
at least one main path configured to extract from the first pair of signals a second pair of phase quadrature signals at a frequency of a selected channel in the band;
an auxiliary path configured to extract from the first pair of signals a third pair of phase quadrature signals at a frequency opposite the frequency of the selected channel;
a matrix configured to perform an amplitude and angular correction of vectors formed by components of the first pair of signals; and
a circuit configured to provide coefficients of the matrix from a correlation product between an error of a first complex signal formed by the second pair of signals relative to its estimated value, and a second complex signal formed by the third pair of signals.

22. The demodulator of claim 21, wherein the at least one main path comprises a plurality of main paths configured to extract from the first pair of signals a plurality of pairs of phase quadrature signals at the frequencies of respective channels selected in the band; and further comprising:
a correction matrix respectively placed in each of the main paths; and
a control circuit configured to operate the auxiliary path successively at the opposite frequencies of the selected channels, and to generate the coefficients of the corresponding matrices.

23. The demodulator of claim 22, wherein the matrix has coefficients determined from a complex value obtained by dividing the correlation product by a power of a received signal corresponding to the second complex signal.

24. The demodulator of claim 23, wherein the complex value resulting from the division is expressed approximately by:
B_{S}=α−jθ,
and the matrix is approximated by:
$$\vert \begin{matrix}1 - α & θ \\ θ & 1 + α\end{matrix} \vert$$
where B_{S} is a factor of imbalance in a channel, α is an amplitude error imbalance and θ is a phase error imbalance.

25. The demodulator of claim 21, wherein the correlation product and the correction are carried out during reception of a header including known symbols, with the estimated value assuming the known values of the symbols.

26. A demodulator to extract data from a plurality of channels within a band, comprising:
a demodulation stage configured to extract a first pair of phase quadrature signals at the center frequency of the band;
a plurality of main paths configured to extract from the first pair of signals a plurality of second pairs of phase quadrature signals at the frequencies of respective channels selected in the band;
an auxiliary path configured to extract from the first pair of signals a third pair of phase quadrature signals at an adjustable frequency;
a respective correction matrix placed in each of the main paths, configured to operate an amplitude and angular correction of the vectors formed by the components of the first pair of signals; and
a control circuit configured to operate the auxiliary path successively at the opposite frequencies of the selected channels, and to establish the coefficients of each matrix from a correlation product based on complex signals formed by the respective second pair of signals and the third pair of signals.

27. The demodulator of claim 26, wherein the control circuit is configured to establish the correlation product between an error of the complex signal formed by the respective second pair of signals relative to its estimated value and the complex signal formed by the third pair of signals.

28. The demodulator of claim 26, wherein the control circuit is configured to determine the matrix coefficients from a complex value obtained by dividing the correlation product by a power of a received signal corresponding to the third pair of signals.

29. The demodulator of claim 28, wherein the complex value resulting from the division is expressed approximately by:
B_{S}=α−j θ,
and the matrix is approximated by:
$$\vert \begin{matrix}1 - α & θ \\ θ & 1 + α\end{matrix} \vert$$
where B_{S} is a factor of imbalance in a channel, α is an amplitude error imbalance and θ is a phase error imbalance.

30. The demodulator of claim 26, wherein the control circuit is configured to carry out the correlation product and the correction during reception of a header including known symbols, with the estimated value assuming the known values of the symbols.
